(19) United States
(12) Patent Application Publication
(10) Pub. No.: US 2002/0176630 A1
(43) Pub. Date: Nov. 28, 2002

(54) Image data processing method

(75) Inventor: Shigeru Tsujita, Kanagawa (JP)

Correspondence Address: Norman P. Soloway, HAYES SOLOWAY PC, 130 W. Cushing Street, Tucson, AZ, 85701, US

(73) Assignee: NEC CORPORATION

(21) Appl. No.: 10/155,258

(22) Filed: May 24, 2002

(30) Foreign Application Priority Data
May 28, 2001 (JP) 158932/2001

(51) Int. Cl. G06K 9/36

(52) U.S. Cl. 382/232; 382/305

(57) ABSTRACT

An image data processing method in accordance with the JPEG compression reduces the necessary amount of process in storing still images and the requirements for the storage capacity of temporary storage. In the image data processing method, when input still image data is JPEG-compressed, a JPEG compressing process is performed on each block including a plurality of MCUs, the JPEG-compressed data of each block is stored in temporary storage, a restart marker is added to the head of each block read from the temporary storage when the JPEG-compressed data is stored, and the resultant data is stored. Thus, a recompressing process is not required between adjacent blocks, and it is not necessary to reserve an area storing a DC coefficient required to recompress data between adjacent blocks in the temporary storage.

### BACKGROUND OF THE INVENTION

1. Field of the Invention

The present invention relates to an image data processing method, and more specifically to an image data processing method in accordance with a JPEG compression.

2. Description of the Prior Art

With increasing demand for higher-precision still images and larger display screens, the amount of image data obtained by digitizing still images has remarkably increased. To reduce the requirements for storage capacity when the digitized still images are stored on storage media, the still images are normally encoded, compressed, and then stored. A method of encoding and compressing the digitized still images can be the JPEG (Joint Photographic Expert Group) standard.

The image data processing method in accordance with the conventional JPEG standard will be described below by referring to FIGS. 1 to 6.

FIG. 1 shows the image processing apparatus according to the conventional JPEG compression. The image processing apparatus includes control means 70, storage 71 for programs, temporary storage 72, a camera unit 73, still image input means 74, uncompressed still image storage 75, and compressed still image storage 76. The camera unit 73 converts a still image fetched from a CCD, etc. using an A/D converter into a digital image signal. The still image input means 74 stores digital image signals output from the camera unit 73 for one frame, and sequentially outputs an image signal for each horizontal line. The uncompressed still image storage 75 stores an image signal for each horizontal line output from the still image input means 74 in a hierarchical structure having a pixel as the least significant unit and an area as the most significant unit. The control means 70 executes an image data processing program stored in the storage 71 for programs, generates a compressed image signal by compressing an image signal output from the uncompressed still image storage 75, and controls each circuit block shown in FIG. 1. The temporary storage 72 temporarily stores a compressed image signal. The compressed still image storage 76 sequentially stores the compressed image signals finally.

FIG. 2 shows the configuration of the still image data for one frame stored in the uncompressed still image storage 75. K (k is a positive integer) continuous MCUs (Minimum Coded Units) 811, 812, . . . , 81k containing m pixels×n pixels (m and n are integers, and m=n=8 in this example) configure one block.

Additionally, V (V is a positive integer) continuous blocks 81 are vertically arranged to form an area containing 0-th area 801 to (H−1)th area 80H. That is, a still image 80 on one frame is equally divided into H divisions by areas 801 to 80H which are a block string of V continuous blocks.

In the example shown in FIG. 2, an MCU 82 is configured by 8 pixels×8 pixels. According to the JPEG compression mode, that is, the sampling ratio between a brilliance signal Y and a chrominance difference signal, the MCU size such as 8 pixels×16 pixels, 16 pixels×16 pixels, etc. is set.

FIG. 3 shows each area in which the still image data shown in FIG. 2 is divided into H divisions by 0-th area 801 to (H−1)th area 80H, and a horizontal line configuring each area. For example, the 0-th area 801 is configured by j horizontal lines 8011, 8012, . . . , 801j.

The still image input means 74 sequentially outputs data from the leftmost pixel data to the rightmost pixel data of a horizontal line 8011 forming the 0-th area 801 to the uncompressed still image storage 75, and then sequentially outputs data from the leftmost pixel data to the rightmost pixel data of a horizontal line 8012 to the uncompressed still image storage 75.

Similarly, it sequentially outputs data from the leftmost pixel data to the rightmost pixel data of a horizontal line 801j to the uncompressed still image storage 75, thereby outputting all pixel data in the 0-th area 801 to the uncompressed still image storage 75.

Then, it sequentially outputs data from the leftmost pixel data to the rightmost pixel data of the uppermost horizontal line forming the first area 802 to the uncompressed still image storage 75, and sequentially outputs data from the leftmost pixel data to the rightmost pixel data of the lowermost horizontal line forming the first area 802 to the uncompressed still image storage 75.

Thus, the still image input means 74 sequentially outputs each pixel data from the uppermost horizontal line to the lowermost horizontal line to the uncompressed still image storage 75 in each area. The still image input means 74 sequentially outputs the image data from the leftmost area 801 to the rightmost area 80H to the uncompressed still image storage 75, thereby outputting the entire pixel data for one frame to the uncompressed still image storage 75. Thus, the uncompressed image data shown in FIG. 2 is stored in the uncompressed still image storage 75.

The method of storing compressed images using the conventional JPEG compression system will be described below by referring to the flowchart shown in FIG. 4. The explanation is given by referring to the conventional compressed image storage shown in FIG. 1.

First, a vertical count value Cv, a horizontal count value Ch, and a serial block number Cn are described.

The vertical count value Cv refers to an array number of a block starting from the uppermost row in each area. In the 0-th area 801 shown in FIG. 2, the vertical count value Cv of the block 0 is 0, the vertical count value Cv of the block H is 1, and the vertical count value Cv of the block (V−1)H is (V−1)

The horizontal count value Ch refers to the array number of an area starting from the leftmost area. The horizontal count value Ch of the 0-th area 801 is 0, the horizontal count value Ch of the first area 802 is 1, the horizontal count value Ch of the (H−1)th area 80H is (H−1).

The serial block number Cn refers to the array number of a block starting from the block at the upper left corner, ending at the lower right corner, and increasing from leftmost to rightmost horizontally, and vertically from top to bottom as shown in FIG. 2. The serial block number Cn is computed using the vertical count value Cv and the horizontal count value Ch by the following equation (1).

Cn=H·Cv+Ch (1)

The vertical count value Cv, the horizontal count value Ch, and the serial block number Cn are count values increasing by 1 sequentially from 0, and the count value is computed by the control means 70 configured by a CPU, etc.

The process steps shown in FIG. 4 can be roughly divided into two groups, that is, the process flow from steps S11 to S101, and the process flow from steps S111 to S119. The outline of the process from steps S11 to S101 will be described below.

That is, the still image input means 74 fetches a still image for one frame from the camera unit 73, and outputs still image data to the uncompressed still image storage 75 in the procedure shown in FIG. 3. The uncompressed still image storage 75 stores the still image data, and outputs the still image data to the control means 70 with respect to each of the blocks according to a control signal from the control means 70.

The control means 70 fetches the image data from the uncompressed still image storage 75 with respect to each of the blocks, performs the JPEG compression, and stores the result in the temporary storage 72. The above mentioned process from steps S11 to S101 is the outline of the conventional method.

Described below will be the outline of the process from steps S111 to S119.

The control means 70 reads the compressed imaged at a stored in the temporary storage 72, refers to the DC coefficients at both ends which are DC components obtained in the DCT (discrete cosine transform) process performed on every 8 pixels×8 pixels of the MCUs on both ends of blocks, and computes the difference value of the DC coefficients at both ends between the adjacent blocks. Then, it quantizes and Huffman-encodes the difference value, generates compressed image data having the configuration as shown in FIG. 6, and stores the compressed image data in the compressed still image storage 76 together with the Huffman-encoded difference value. Described above is the outline of the process in steps S111 to S119.

Then, the method of storing a compressed image using the conventional JPEG compression system will be practically described below by referring to FIG. 4.

In step S11, the vertical count value Cv and the horizontal count value Ch are initialized. Practically, each count value is set to 0.

Then, in step S12, the vertical count value Cv and the horizontal count value Ch are assigned to the equation (1) to compute the serial block number Cn. In step S13, the control means 70 inputs a block corresponding to the serial block number Cn computed in step S12 through the uncompressed still image storage 75.

In step S14, the control means 70 performs the JPEG compression on the image data of the input block in the procedure according to the standards (ISO/IEC 10918). That is, it performs the DCT on the image data of each MCU in a block in the JPEG compression, quantizes the obtained DCT coefficient, computes the difference in DC coefficient between adjacent MCUs, and performs a compressing process through the Huffman coding which is one of the entropy coding systems. Then, in step S15, the compressed image data is stored in the temporary storage 72. At this time, since each of the MCUs on both ends of a block are not assigned its adjacent MCU and no difference value can be computed, the DC coefficient of the leftmost MCU and the DC coefficient of the rightmost MCU are stored in the temporary storage 72 as the DC coefficients at both ends.

Then, in step S16, for the DC coefficients at both ends of the serial block number Cn, that is, in the first block, the DC coefficient obtained by performing the DCT operation on the MCUs 811 and 81k on both ends of the block 0 shown in FIG. 2 is stored in the temporary storage 72.

Then, in step S17, 1 is added to the vertical count value Cv, and a block to be processed is updated. Then, in step S18, it is determined whether the vertical count value Cv is equal to or larger than V−1 or not. If the vertical count value Cv is equal to or larger than V−1, then the next process step S19 is performed. If the vertical count value Cv is smaller than V−1, then control is returned to step S12, and the serial block number Cn of the next block is computed. Thus, the process in steps S14 through S16 is sequentially performed on all blocks from top to bottom in the area.

In step S19, 1 is added to the horizontal count value Ch, and a block to be processed is updated. Then, in step S101, it is determined whether the horizontal count value Ch is equal to or larger than H−1 or not. If the horizontal count value Ch is equal to or larger than H−1, then the next process step S111 is performed. If the horizontal count value Ch is smaller than H−1, then control is returned to step S12, and the serial block number Cn of the next block is computed. Thus, the process in steps S14 to S16 is sequentially performed on all areas forming a frame from leftmost to rightmost and all blocks forming an area.

Described below will be the process in steps S111 to S119 shown in the second half of FIG. 4.

In step S111, the serial block number Cn is initialized. Practically, the count value is set to 0. Then, in step S112, the compressed image data in the block at the upper left corner shown in FIG. 2 corresponding to the serial block number Cn computed in step S111, that is, the block 0, is stored in the compressed still image storage 76. Then, in step S113, 1 is added to the serial block number Cn, and a block to be processed is updated.

Then, in step S114, the difference values of DC coefficients at both ends between adjacent blocks of the serial block number Cn and the serial block number C(n−1) are computed. For example, the DC coefficient corresponding to the rightmost MCU in the DC coefficients at both ends of the block having the serial block number Cn of 0 is subtracted from the DC coefficient corresponding to the leftmost MCU in the DC coefficients at both ends of the block having the serial block number Cn of 1. Since the leftmost MCU in the block having the serial block number Cn of 0 has no block from which a difference is to be obtained, the compressed image data of the block 0 is stored as is in the compressed still image storage 76 in step S112.

In step S115, the difference values of the DC coefficients at both ends computed in step S114 are quantized. Then, in step S116, the quantized difference values are Huffman-encoded.

In step S117, the Huffman-encoded difference values are written at the head of the compressed image data of the block having the serial block number Cn. Then, in step S118, the compressed image data of the block having the serial block number Cn is stored in the compressed still image storage 76 after the Huffman-encoded difference value.

In step S119, the control means 70 determines whether the compressed image data has been stored in the compressed still image storage 76 in all blocks forming a still image for one frame or not. If it is determined that the compressed image data in all blocks have been stored in the compressed still image storage 76, then the image process shown in FIG. 4 terminates by determining that the image process has been completed on all pixel data in the frame. If it is determined that there is an unprocessed block, then control is returned to step S113, and the next block to be processed is input.

Thus, the compressed image data in each block is stored in the compressed still image storage 76 after the Huffman-encoded difference value in the order of block 0, block 1, . . . , block (H−1), block H, block (H+1), . . . , block (2H−1), block 2H, . . . , the block at the lower right corner in the blocks from the block having the first serial block number at upper left corner to the block having the last serial block number at the lower right corner in the frame.

FIG. 5 is a memory map showing the compressed image data of each block stored in the temporary storage 72, and the DC coefficients at both ends of each block written at the head of each block.

FIG. 6 shows the memory map of the Huffman-encoded difference values followed by the compressed image data of each block stored in the compressed still image storage 76. However, the data at the head of the block 0 stores the compressed image data of the block 0 as it is.

In the above mentioned conventional method of processing image data according to the JPEG compression system, a still image for one frame is divided for each area as shown in FIG. 2. The block is input sequentially in a line unit as shown in FIG. 3, and is sequentially encoded, thereby compressing the image data. Therefore, if the DC coefficients at both ends of the left adjacent block are not computed as described above in steps S114 to S118 shown in FIG. 4, then the still image in the block cannot be compressed.

For example, the block ((V−1)H+H−1) shown in FIG. 2 cannot be compressed if the DC coefficients at both ends of the left adjacent block ((V−1)H+H−2) have not been computed.

Therefore, it is necessary to store in the temporary storage 72 the compressed image data of each block for one frame and the DC coefficients at both ends of each block added at the head of each block. As a result, there occurs the problem that the temporary storage 72 requires a large storage capacity.

Furthermore, as the DC coefficients at both ends written at the head of each block shown in FIG. 5 are described in steps S114 to S116 shown in FIG. 4, since the process of obtaining a difference between DC coefficients at both ends, the quantizing process on the difference, and the Huffman coding process are to be continuously performed, the amount of processes to be performed by the control means 70 increases.

### SUMMARY OF THE INVENTION

The present invention has been developed to solve the above mentioned problems with the conventional technology, and aims at providing an image data processing method for reducing the requirements for the storage capacity of the temporary storage by reducing the amount of processes required to store still images. According to the present invention, the still image divided in each area as shown in FIG. 2 is sequentially input into the control means in a horizontal line unit for each area as shown in FIG. 3, the JPEG compressed data of each block is temporarily stored when the input still image data is sequentially JPEG-compressed, and the compressed image data and the restart marker are stored in the compressed still image storage while adding a restart marker corresponding to the compressed image data, thereby attaining the purpose of the present invention.

Therefore, the image data processing method according to the present invention includes: a first procedure including the steps of inputting still image data forming a frame, dividing the still image data into blocks each of which contains a predetermined number of consecutive MCUs, sequentially selecting a block as a selected block in the horizontal-scan direction of the frame, compressing the still image data in the selected block according to the JPEG standard and generating compressed image data, and storing the compressed image data corresponding to the selected block in temporary storage; and a second procedure including the steps of sequentially reading the compressed image data from the temporary storage for each of the blocks in the primary scan direction, and adding a restart marker at the head of each of the blocks and outputting the data.

According to another aspect of the present invention, the image data processing method includes: a first procedure including the steps of inputting still image data forming a frame, dividing the still image data into blocks each of which contains a predetermined number of consecutive MCUs, sequentially selecting a block as a selected block in the horizontal-scan direction of the frame, dividing the selected block into a first half block and a second half block at the boundary between MCUs, compressing the still image data contained in the first half block according to the JPEG standard and then adding a restart marker at the end of compressed image data of the first half block, compressing the still image data contained in the second half block according to the JPEG standard and generating compressed image data of the second half block, and storing the compressed image data of the second half block next to the restart marker in the temporary storage; and the second procedure including the steps of sequentially reading the compressed image data from the temporary storage in the primary scan direction, and adding a restart marker at the head of each of the blocks and then outputting the data.

The above mentioned and other objects, features and advantages of the present invention will become more apparent by reference to the following detailed description and claims of the invention taken in conjunction with the accompanying drawings.

### BRIEF DESCRIPTION OF THE DRAWINGS

This above-mentioned and other objects, features and advantages of this invention will become more apparent by reference to the following detailed description of the invention taken in conjunction with the accompanying drawings, wherein:

FIG. 1 is a block diagram of the still imaged at a processing apparatus for use with the conventional JPEG compression system;

FIG. 2 is a memory map for explanation of the configuration of the still image data for one frame stored in the uncompressed still image storage;

FIG. 3 shows the order of the still image input means outputting still image data for one frame to the uncompressed still image storage;

FIG. 4 is a flowchart for explanation of the conventional image data processing method;

FIG. 5 is a memory map of the compressed image data and the DC coefficients at both ends stored in the temporary storage in the conventional image data processing method;

FIG. 6 is a memory map of the compressed image data and the Huffman-encoded difference value stored in the compressed still image storage in the conventional image data processing method;

FIG. 7 is a block diagram of the still imaged at a processing apparatus to which the present invention is applied;

FIG. 8 is a flowchart according to a first embodiment of the image data processing method of the present invention;

FIG. 9A is a memory map of the compressed image data stored in the temporary storage according to the first embodiment of the image data processing method of the present invention;

FIG. 9B is a memory map of the compressed image data and the restart marker RST finally stored in the compressed still image storage according to the first embodiment of the image data processing method of the present invention;

FIG. 10 is a memory map of the compressed image data and the restart marker RST stored in the temporary storage according to a second embodiment of the image data processing method of the present invention;

FIG. 11 is a flowchart according to the second embodiment of the image data processing method of the present invention; and

FIG. 12 is a memory map of the compressed image data and the restart marker RST stored in the temporary storage according to a third embodiment of the image data processing method of the present invention.

### DETAILED DESCRIPTION OF THE PREFERRED EMBODIMENTS

The preferred embodiments of the present invention will be described below in detail by referring to the attached drawings. The explanation below relates to the embodiments of the present invention, and the present invention is not limited to the applications in the explanation.

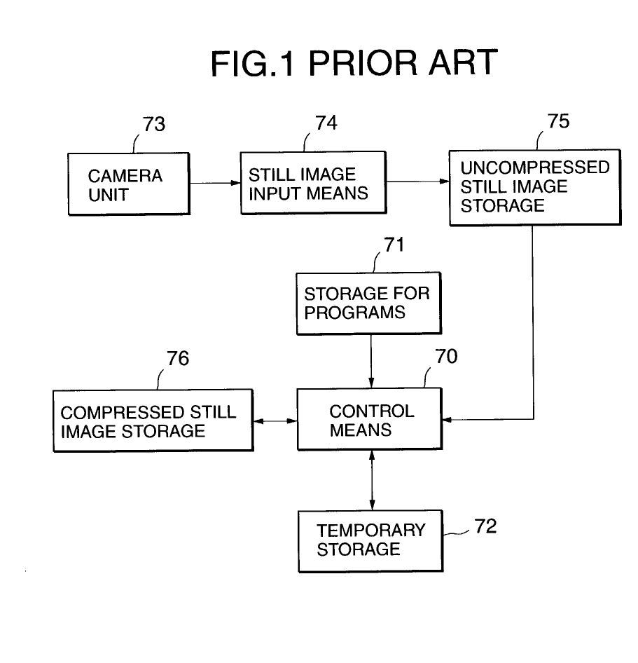

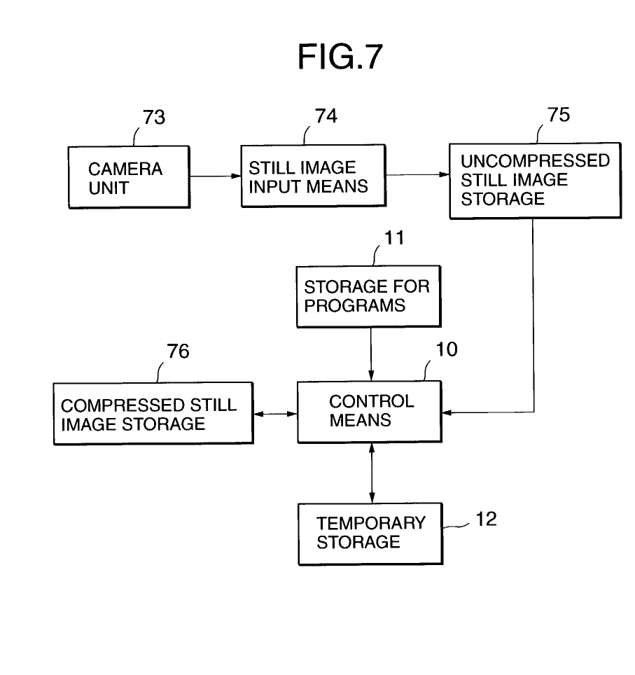

FIG. 7 is a block diagram of an embodiment of the image processing apparatus according to the present invention. Each circuit block shown in FIG. 7 corresponding to each circuit block shown in FIG. 1 is generally the same in function as that shown in FIG. 1. The common components between FIGS. 1 and 7 are assigned the same reference characters/numerals.

The image processing apparatus shown in FIG. 7 comprises: control means 10, storage 11 for programs, temporary storage 12, a camera unit 73, still image input means 74, uncompressed still image storage 75, and compressed still image storage 76. The camera unit 73 converts a still image fetched from a CCD, etc. using an A/D converter into a digital image signal. The still image input means 74 stores digital image signals output from the camera unit 73 for one frame, and sequentially outputs an image signal for each horizontal line. The uncompressed still image storage 75 stores an image signal for each horizontal line output from the still image input means 74 in a hierarchical structure having a pixel as the least significant unit and an area as the most significant unit. The control means 10 executes an image data processing program stored in the storage 11 for programs, generates a compressed image signal by compressing an image signal output from the uncompressed still image storage 75, and controls each circuit block shown in FIG. 1. The temporary storage 12 temporarily stores a compressed image signal. The compressed still image storage 76 sequentially stores the compressed image signals finally.

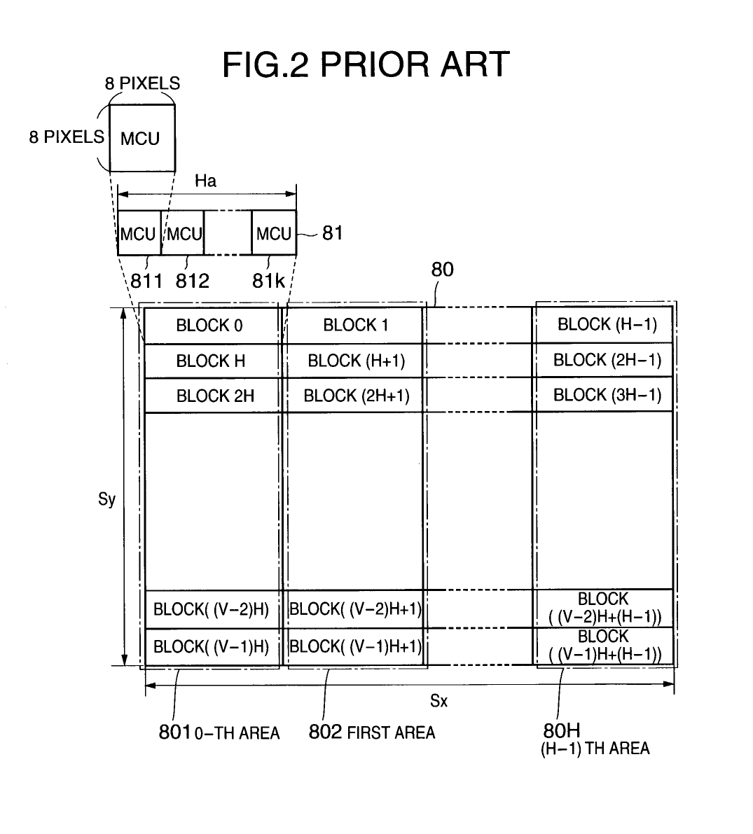

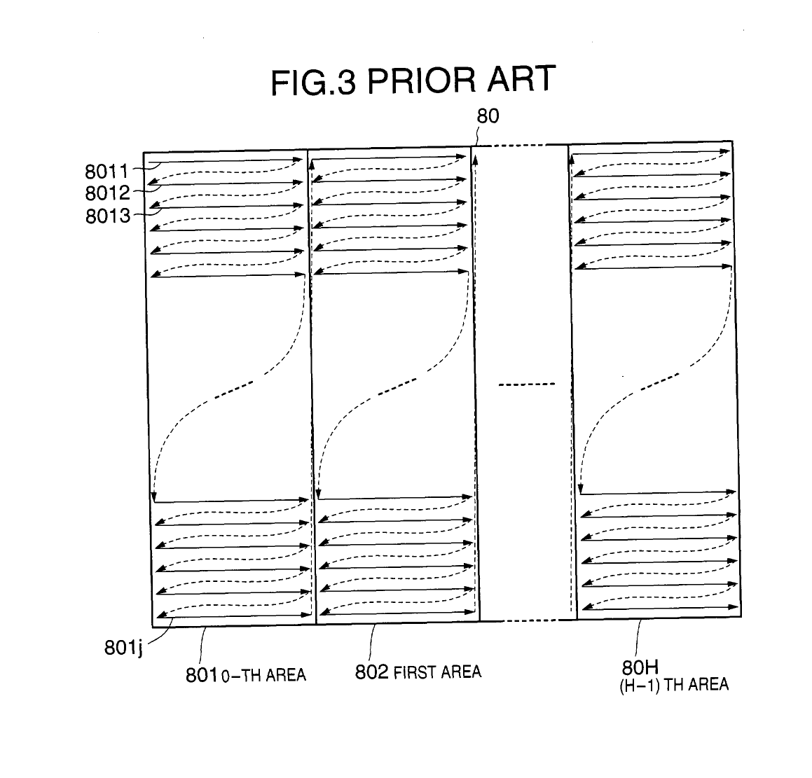

FIG. 2 is a memory map showing the configuration of the still image on one frame stored in the uncompressed still image storage 75. FIG. 3 shows each area in which the still image data shown in FIG. 2 is divided into H divisions by 0-th area 801 to (H−1)th area 80H, and a horizontal line configuring each area as in the conventional image processing apparatus shown in FIG. 1.

The still image input means 74 sequentially outputs data from the leftmost pixel data to the rightmost pixel data of a horizontal line 8011 forming the 0-th area 801 to the uncompressed still image storage 75, and then sequentially outputs data from the leftmost pixel data to the rightmost pixel data of a horizontal line 8012 to the uncompressed still image storage 75.

Similarly, it sequentially outputs data from the leftmost pixel data to the rightmost pixel data of a horizontal line 801j to the uncompressed still image storage 75, thereby outputting all pixel data in the 0-th area 801 to the uncompressed still image storage 75.

Then, it sequentially outputs data from the leftmost pixel data to the rightmost pixel data of the uppermost horizontal line forming the first area 802 to the uncompressed still image storage 75, and sequentially outputs data in a line unit from the leftmost pixel data to the rightmost pixel data of the lowermost horizontal line forming the first area 802 to the uncompressed still image storage 75.

Thus, the still image input means 74 sequentially outputs each pixel data from the uppermost horizontal line to the lowermost horizontal line to the uncompressed still image storage 75 in each area. The still image input means 74 sequentially outputs the image data from the leftmost area 801 to the rightmost area 80H to the uncompressed still image storage 75, thereby outputting the entire pixel data for one frame to the uncompressed still image storage 75. Thus, the uncompressed image data shown in FIG. 2 is stored in the uncompressed still image storage 75.

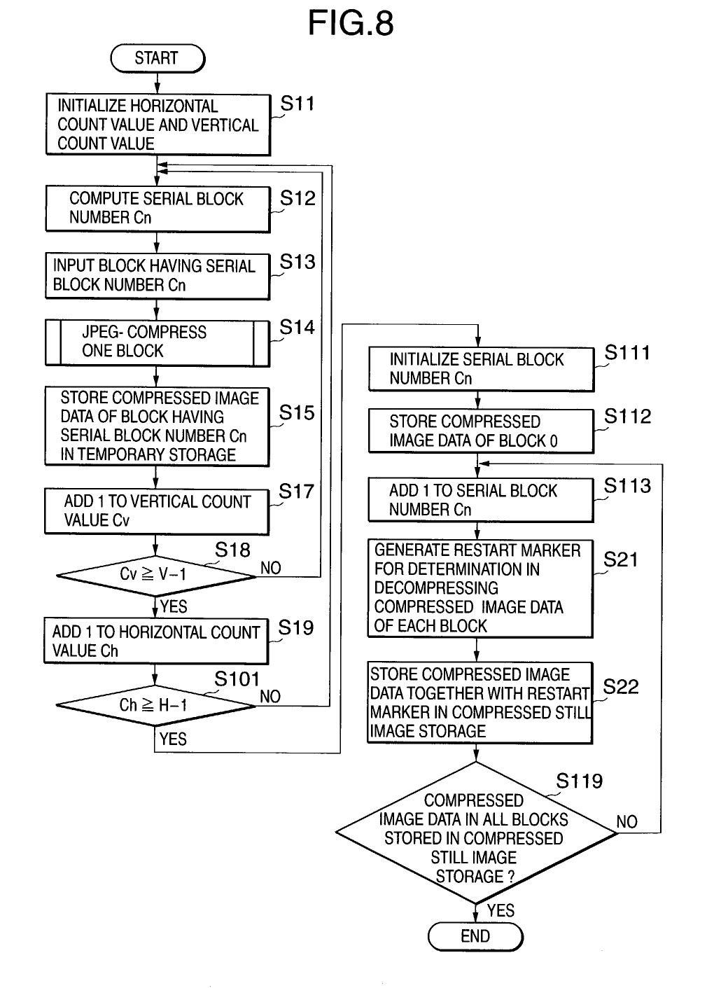

The image data processing method according to the present invention will be described below by referring to the flowchart shown in FIG. 8, and using the image processing apparatus shown in FIG. 7.

The vertical count value Cv, the horizontal count value Ch, and the serial block number Cn are the same as those described above by referring to the conventional image processing apparatus and image data processing method, but the control means 10 configured by a CPU, etc. can compute a count value through a software program, or control means 10 can be provided with a vertical counter, a horizontal counter, and a serial block number counter for computing respective count values as hardware.

The process steps shown in FIG. 8 can be roughly divided into the process flow from the left steps S11 to S101 and the process flow from the right steps S111 to S119. The outline of the process from steps S11 to S101 will be described below.

That is, the still image input means 74 fetches a still image for one frame from the camera unit 73, and outputs still image data to the uncompressed still image storage 75 in the procedure shown in FIG. 3. The uncompressed still image storage 75 stores the still image data, and outputs the still image data to the control means 10 with respect to each of the blocks according to a control signal from the control means 10.

The control means 10 fetches the image data from the uncompressed still image storage 75 with respect to each of the blocks, performs the JPEG compression, and stores the result in the temporary storage 12. The above mentioned process from steps S11 to S101 is the outline of the conventional method.

Described below will be the outline of the process from steps S111 to S119.

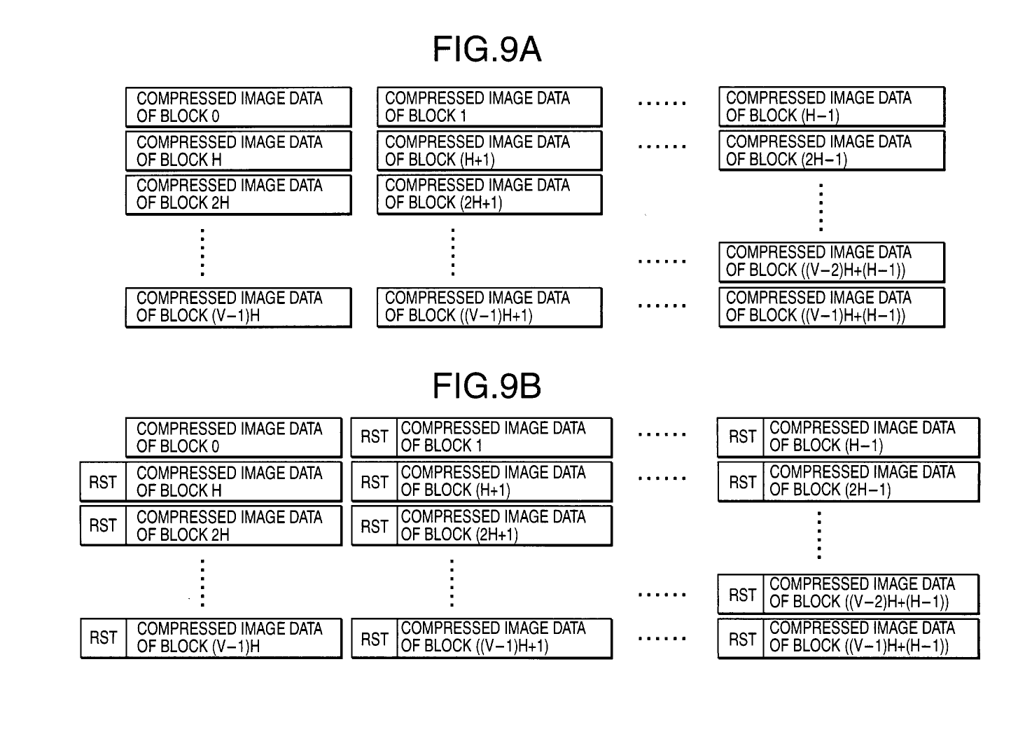

The control means 10 reads the compressed image data stored in the temporary storage 12, and generates a restart marker for a block to be processed. Then, the control means 10 stores the compressed image data in the compressed still image storage 76 in the data array as shown in FIG. 9A. The above mentioned process is the outline of the process in steps S111 to S119.

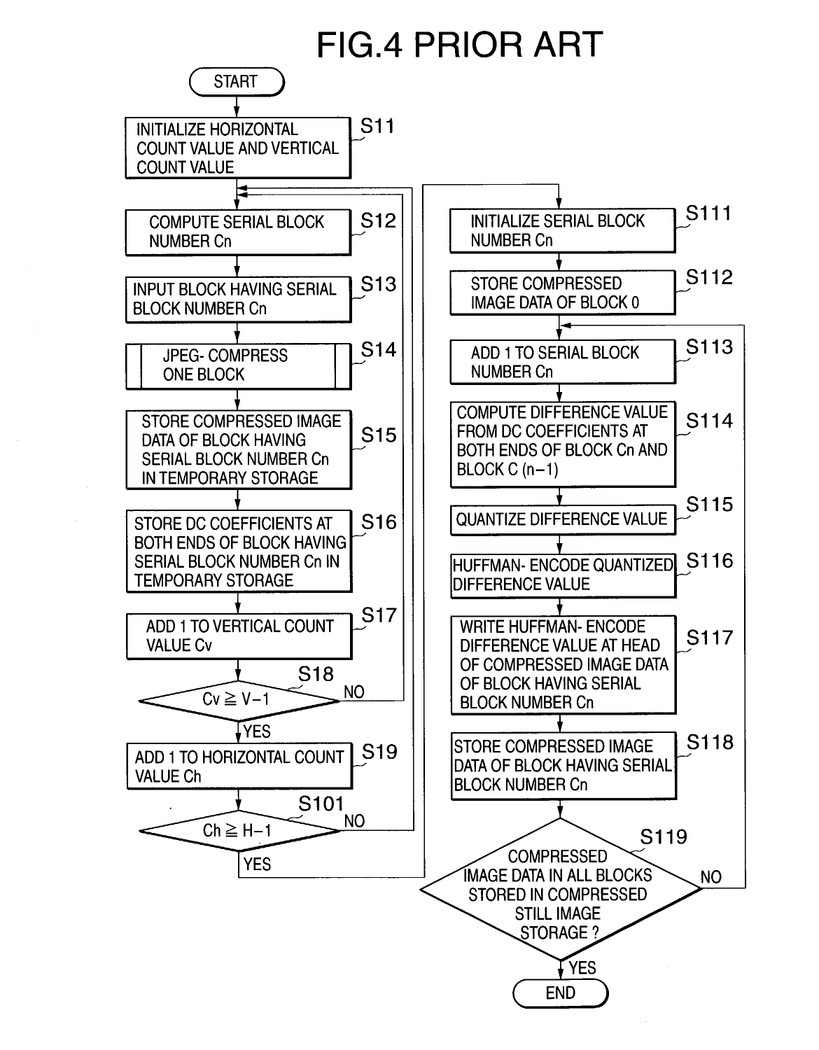

As it is clearly described above, the process of storing the DC coefficients at both ends in the temporary storage 72 in the process step S16 shown in FIG. 4 and the process of computing the differences between the DC coefficients at both ends of adjacent blocks, quantizing and Huffman-encoding the difference value, inserting the Huffman-encoded difference value at the head of the compressed image data, and writing the resultant data to the uncompressed still image storage 75 in steps S114 to S117 are omitted here. In step S21, the process step of generating a restart marker to be written at the head of the compressed image data is newly set for the uncompressed still image storage 75. Therefore, since there are a smaller number of process steps than in the conventional image data processing method, thereby realizing a high-speed image process.

Described below will be the restart marker prescribed by the JPEG standard. According to the JPEG standard, compressed image data can be correctly decompressed although a data error has occurred in the communications, etc. When a restart marker appears during the decompressing process on compressed image data, it is not necessary to perform computation using DC coefficients of the block immediately before, and the data can be decompressed. That is, the restart marker has the control function by interrupting the chain of difference compression for DC coefficients, and the difference of the DC coefficients immediately after the restart marker from 0 is entropy coded and compressed. Therefore, an absolute value of a DC coefficient on both ends is stored with compressed image data in the storage area storing compressed image data with a restart marker, and the difference values of DC coefficients at both ends between adjacent blocks are stored with compressed image data in the storage area storing compressed image data without a restart marker in conventional technology.

The image data processing method according to the present invention will be described below in detail by referring to FIG. 8.

In step S11, the vertical count value Cv and the horizontal count value Ch are initialized. Practically, each count value is set to 0.

Then, in step S12, the vertical count value Cv and the horizontal count value Ch are assigned to the equation (1) to compute the serial block number Cn. In step S13, the control means 10 inputs a block corresponding to the serial block number Cn computed in step S12 through the uncompressed still image storage 75.

In step S14, the control means 10 performs the JPEG compression on the image data of the input block in the procedure according to the standards (ISO/IEC 10918). That is, it performs the DCT on the image data of each MCU in a block in the JPEG compression, quantizes the obtained DCT coefficient, computes the difference in DC coefficient between adjacent MCUs, and performs a compressing process through the Huffman coding. Then, in step S15, the compressed image data is stored in the temporary storage 12.

Then, in step S17, 1 is added to the vertical count value Cv, and a block to be processed is updated. Then, in step S18, it is determined whether the vertical count value Cv is equal to or larger than V−1 or not. If the vertical count value Cv is equal to or larger than V−1, then the next process step S19 is performed. If the vertical count value Cv is smaller than V−1, then control is returned to step S12, and the serial block number Cn of the net block is computed. Thus, the process in steps S14 and S15 is sequentially performed on all blocks from top to bottom in the area.

In step S19, 1 is added to the horizontal count value Ch, and a block to be processed is updated. Then, in step S101, it is determined whether the horizontal count value Ch is equal to or larger than H−1 or not. If the horizontal count value Ch is equal to or larger than H−1, then the next process step S111 is performed. If the horizontal count value Ch is smaller than H−1, then control is returned to step S12, and the serial block number Cn of the next block is computed. Thus, the process in steps S14 and S15 is sequentially performed on all areas forming a frame from leftmost to rightmost and all blocks forming an area.

Described below will be the process in steps S111 to S119 shown in the second half of FIG. 8.

In step S111, the serial block number Cn is initialized. Practically, the serial block number Cn is set to 0. Then, in step S112, the compressed image data in the block at the upper left corner corresponding to the serial block number Cn computed in step S111, that is, the block 0, is stored in the compressed still image storage 76. Then, in step S113, 1 is added to the serial block number Cn, and a block to be processed is updated.

Then, in step S21, a restart marker for determination in decompressing compressed image data in each block is generated. In step S22, each piece of compressed image data is added at the head of the compressed image data, and is stored together with the restart marker in the compressed still image storage 76. At this time, no restart marker is stored at the head of the compressed image data of the leading block 0.

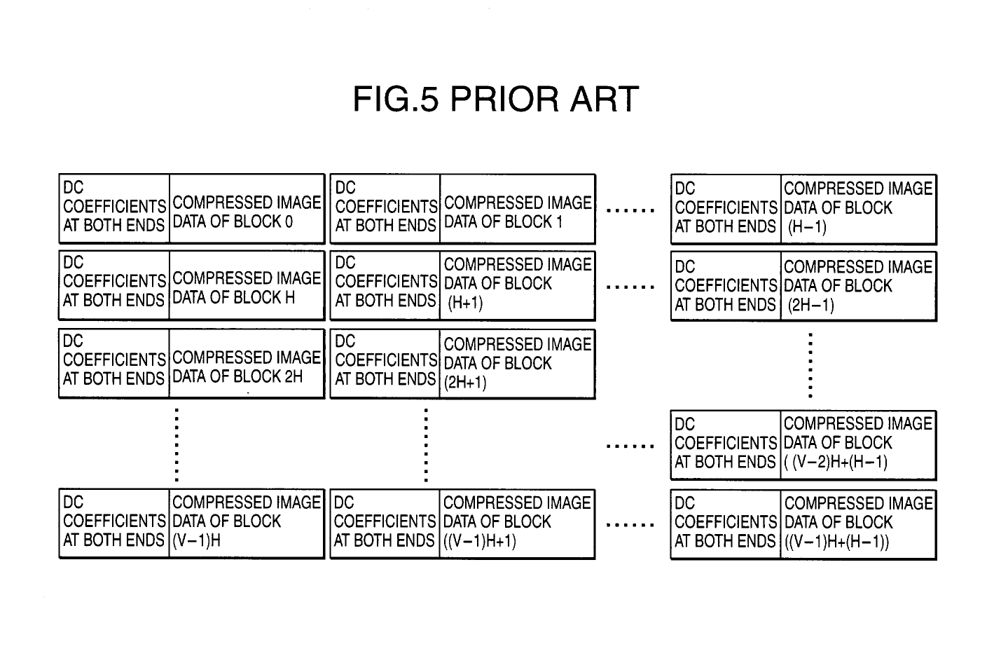

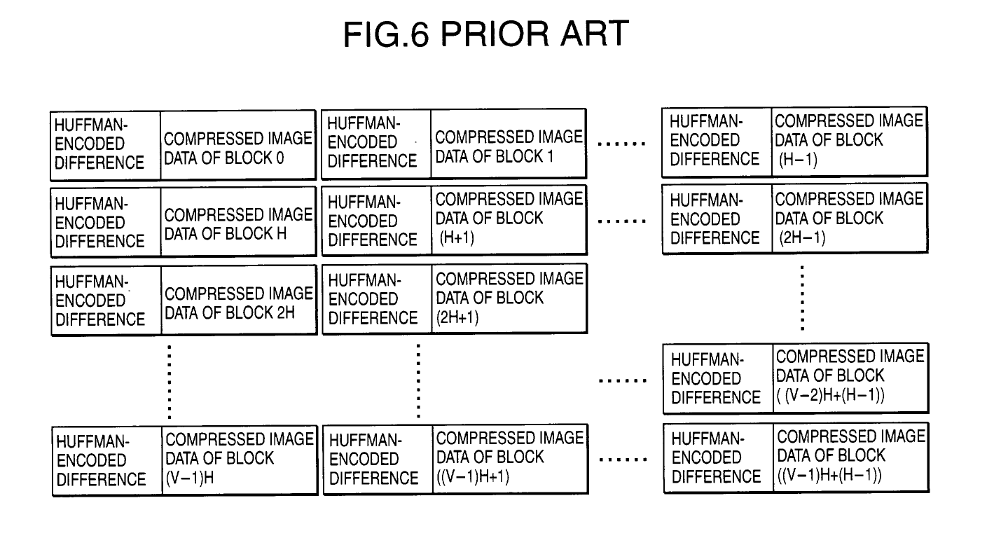

FIG. 9A is a memory map of the compressed image data stored in the temporary storage 12 shown in FIG. 7 in step S15 shown in FIG. 8. As it is clear in comparison with FIG. 5 showing the memory map of the conventional temporary storage 72, the temporary storage 12 stores only the compressed image data, and no additional information such as DC coefficients at both ends is stored. Therefore, the temporary storage 12 according to the present invention requires a smaller storage capacity than the conventional temporary storage 72.

FIG. 9B is a memory map of compressed image data stored instep S22 shown in FIG. 8 in the compressed still image storage 76 shown in FIG. 7, and RST denotes a restart marker. Excluding the leading block 0, a restart marker RST is stored at the head of the compressed image data in all blocks. When compressed image data is decompressed, a decompressing process is performed using the restart marker RST.

In step S119, the control means 10 determines whether the compressed image data has been stored in the compressed still image storage 76 in all blocks forming a still image for one frame or not. If it is determined that the compressed image data in all blocks have been stored in the compressed still image storage 76, then the image process shown in FIG. 8 terminates by determining that the image process has been completed on all pixel data in the frame corresponding to each of the blocks. If it is determined that there is an unprocessed block, then control is returned to step S113, and the next block to be processed is input.

Thus, according to the flowchart of the process from steps S11 to S101 shown in FIG. 8, the image processing apparatus stores the compressed image data in each block in the temporary storage 12 in the order of block 0, block H, . . . , block (V−1)H, block 1, block (H+1), . . . , block ((V−1)H+1), block (H−1), . . . , the block at the lower right corner in the blocks from the block having the first serial block number at upper left corner to the block having the last serial block number at the lower right corner in the frame.

Furthermore, according to the flowchart of the process from steps S111 to S119 shown in FIG. 8, the image processing apparatus stores the compressed image data in each block in the compressed still image storage 76 together with the restart marker added at the head of the compressed image data in the order of block 0, block 1, . . . , block (H−1), block H, block (H+1), . . . , block (2H−1), block 2H, . . . , the block at the lower right corner in the blocks from the block having the first serial block number at upper left corner to the block having the last serial block number at the lower right corner in the frame.

In the description above, still images forming one frame are stored corresponding to each of the blocks in the temporary storage 12 and the compressed still image storage 76. When still images forming a plurality of frames are stored in the temporary storage 12 and the compressed still image storage 76, the compressed image data stored in the temporary storage 12 is updated into newly compressed image data obtained by the control means 10 further encoding and compressing the data. That is, the compressed image data stored in the temporary storage 12 is stored as overwritten data because the compressed image data stored in the temporary storage 12 becomes unnecessary when it is stored in the compressed still image storage 76.

On the other hand, the compressed image data stored in the compressed still image storage 76 is not updated into newly compressed image data obtained by the control means 10 newly encoding and compressing the data, but the newly compressed image data is stored in a storage area different from the storage area storing the previous compressed image data. Thus, by having different storage areas for the still images of the consecutively input frames, an arbitrary compressed still image can be independently decompressed from among a plurality of compressed still images.

According to the present embodiment, to store compressed image data for one frame in the temporary storage 12, the temporary storage 12 is assigned (V×H) memory units (not shown in the attached drawings) of temporary storage having the capacity of storing one block of compressed still image data because the memory units of the temporary storage 12 has to store the largest amount of compressed image data. The storage capacity of each memory unit of the temporary storage is determined with the largest amount of compressed image data taken into account. Although FIG. 9 does not show the memory unit of the temporary storage, each of the (V×H) memory units of temporary storage stores the compressed image data in blocks 0, 1, . . .

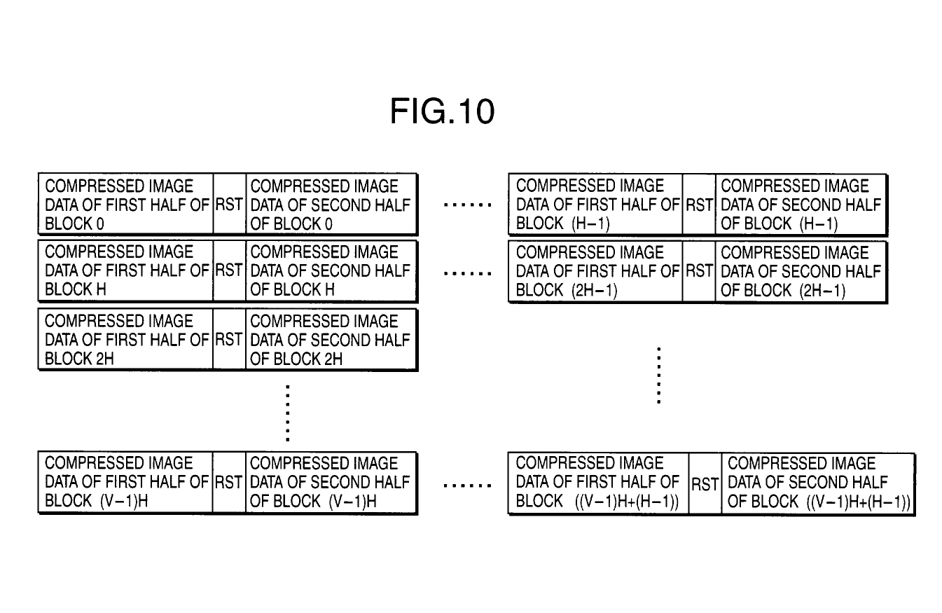

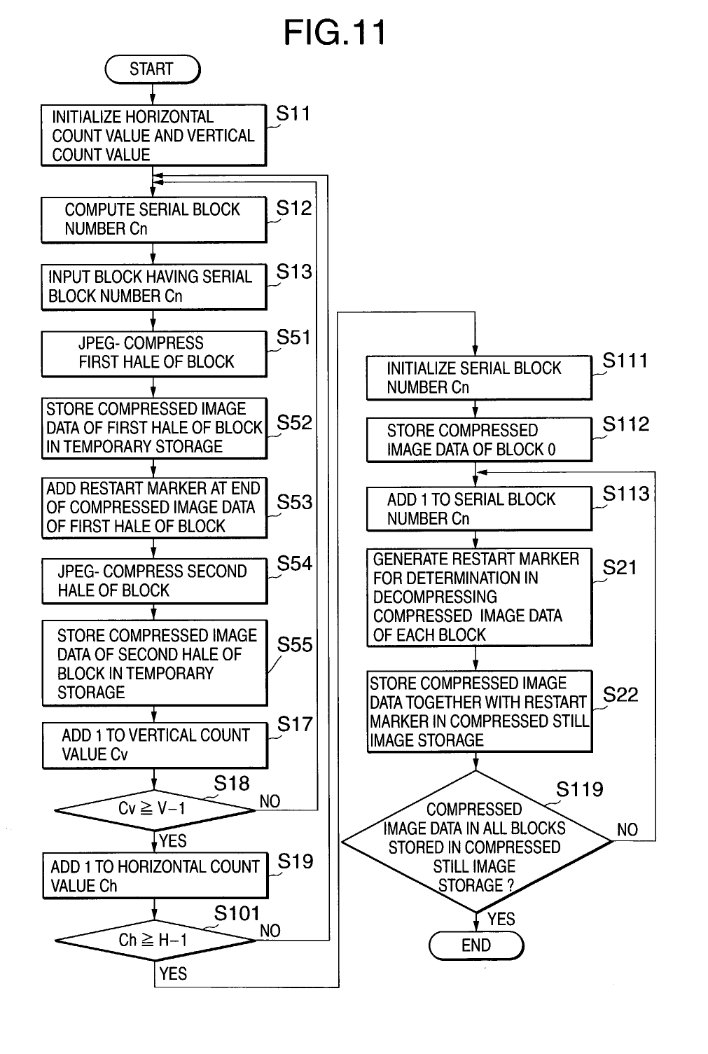

A second embodiment of the image data processing method according to the present invention will be described below by referring to FIGS. 10 and 11.

FIG. 10 is a memory map of the compressed image data and the restart marker RST stored in the temporary storage 12 shown in FIG. 7 in the image data processing method according to the second embodiment of the present invention. Unlike the memory map of the compressed image data stored in the temporary storage 12 shown in FIG. 7 in the image data processing method according to the first embodiment of the present invention shown in FIG. 9A, a restart marker RST is inserted into one block of compressed image data.

When a still image is large and the number of divisions in the horizontal direction, that is, the number of areas is small, the insertion interval of the restart marker RST is longer. A restart marker RST is normally inserted to avoid the deterioration of the quality of images by the loss, etc. of JPEG compressed data when compressed still images are decompressed.

However, when the insertion interval of the restart marker RST becomes longer, it is difficult to correct the loss entirely on the large amount of compressed image data if the loss occurs on a part of the JPEG compressed data. Therefore, if the restart marker RST is inserted into a portion other than the divisions of the image data according to the present embodiment, then the area of compressed image data to be corrected using one restart marker RST becomes smaller, thereby reducing the deterioration of the quality of an image in the entire compressed images containing the lost compressed image data.

The image data processing method according to the present embodiment will be described below in detail by referring to FIG. 11.

The processes in steps S11 to S13 are the same in the image data processing method according to the first embodiment shown in FIG. 8.

In step S51, a part of a less significant block hierarchically forming a block, for example, the still image data in the first half block of the two divisions of the block is JPEG-compressed. Then, in step S52, the still image data JPEG-compressed in step S51, for example, the compressed image data for the still image data in the first half of the block, is stored in the temporary storage 12.

Then, in step S53, a restart marker RST is added to the end of the compressed image data of the first half of the block, and the restart marker RST is stored in the temporary storage 12.

Similarly, in step S54, the remaining part of the less significant block in the blocks, for example, the still image data in the second half block of the two divisions of the block is JPEG-compressed. Then, in step S55, the still image data JPEG-compressed in step S54, for example, the compressed image data for the still image data in the second half of the block is stored next to the restart marker in the temporary storage 12.

Since the processes after step S17 are the same as those in the image data processing method according to the first embodiment shown in FIG. 8, the explanation is omitted here. In the above mentioned second embodiment of the present invention, as in the first embodiment, a restart marker is added also at the head of a block in steps S21 and S22, and is stored together with the restart marker inserted into the block.

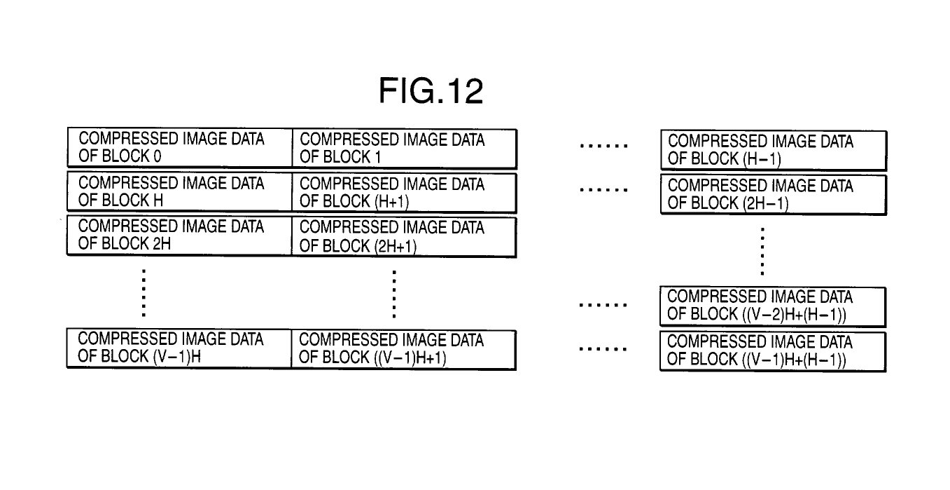

Then, a third embodiment of the image data processing method according to the present invention will be described below by referring to FIG. 12.

In the image data processing method according to the first and second embodiments of the present invention, to store compressed image data for one frame in the temporary storage 12, the temporary storage 12 is assigned (V×H) memory units of temporary storage having the capacity of storing one block of compressed still image data, and the compressed image data in each block is stored in a memory unit of the temporary storage. In the image data processing method according to the third embodiment of the present invention, when the temporary storage 12 stores the compressed image data in each block, that is, when the process corresponding to the process in step S15 according to the first embodiment is performed, the control means 10 stores the address of the compressed image data and the compressed image data size stored in the temporary storage 12. Thus, as shown in FIG. 12, the compressed image data of the block to be subsequently processed is filled immediately after the compressed image data of the block immediately before, and can be stored in the temporary storage 12.

In this method, since there are no memory areas unavailable by the temporary storage 12 when the compressed image data has variable length, the memory space of the temporary storage 12 can be effectively used.

There can be several more practical examples of the image data processing method according to the third embodiment of the present invention. Practically, a program for exclusive use by the storage 11 for programs is prepared, the exclusive program manages the address of the compressed image data stored in the temporary storage 12 and the compressed image data size, and the compressed image data in a block to be processed is filled continuously without a space as shown in FIG. 12 for storage in the temporary storage 12. Another method can be realized by reserving a storage area for dynamically storing compressed image data through a system call, etc. of the operating system having the function of managing memory, and storing the compressed image data without a space in the reserved storage area.

In any method, since there are no memory areas unavailable by the temporary storage 12 when the compressed image data is variable length, the memory space of the temporary storage 12 can be effectively used.

As described above according to the image data processing method of the present invention, when still images divided into areas are sequentially input in a horizontal line unit for each line, and the input still image data is JPEG-compressed, the JPEG-compressed data corresponding to each of the blocks is temporarily stored together with a restart marker added. In this method, since it is not necessary to store in the temporary storage additional information such as the DC coefficients at both ends, etc. required when compressed image data is decompressed, the capacity requirements for the temporary storage can be reduced as compared with the conventional temporary storage, thereby reducing the required storage capacity of the entire image processing apparatus.

According to more practical explanation, the amount of information about the DC coefficients at both ends is proportional to the number of blocks. There are two DC coefficients at both ends of the blocks each having an area of 8 pixels vertically and 8 pixels horizontally obtained by converting MCU image data into frequency components in each of the three elements of the brilliance and two types of chrominance difference.

Since each of the DC coefficients at both ends is two bytes, the DC coefficients at both ends per block are 2 bytes×2×3=12 bytes, thereby requiring 12 bytes per block.

Therefore, assuming that the number of divisions of the still images in the horizontal direction, that is, the number of areas, is 4, and the number of blocks in the vertical direction is 128, a storage capacity for DC coefficients at both ends of 12 bytes×4×128=6,144 bytes is required. To compress and store still images for one frame in compressed still image storage, the conventional system requires 6,144 bytes for one frame. On the other hand, according to the image data processing method of the present invention, the above mentioned storage capacity is not required, thereby considerably reducing the necessary storage capacity.

Additionally, the image data processing method according to the present invention does not require the process of storing the DC coefficients at both ends in temporary storage, computing the difference between the DC coefficients at both ends of adjacent blocks, quantizing and Huffman-encoding the difference value, and inserting the Huffman-encoded difference value at the head of the compressed image data, which have been required by the conventional image data processing method, thereby successfully reducing the number of process steps as compared with the conventional image data processing method, and realizing a high-speed image process.

What is claimed is:

1. An image data processing method, comprising:
a first procedure of inputting still image data forming a frame, dividing said still image data into blocks each of which contains a predetermined number of consecutive minimum coded units, sequentially selecting a blocks as a selected block from said blocks in the horizontal-scan direction of said frame, compressing still image data in said selected block according to the JPEG standard and generating compressed image data, and storing said compressed image data corresponding to said selected block in temporary storage; and
a second procedure of sequentially reading compressed image data of each of said blocks from said temporary storage in a primary scan direction, and adding a restart marker at a head of each of said blocks and outputting.

2. The image data processing method according to claim 1, wherein
said still image data forming said frame is divided into a plurality of areas each including a plurality of blocks, and said first procedure is replaced with a procedure of sequentially selecting a block as a selected block for each area in a horizontal-scan direction in said frame, generating compressed image data by compressing still image data in said selected block in accordance with the JPEG standard, and storing said compressed image data corresponding to said selected block in temporary storage.

3. The image data processing method according to claim 1, wherein
said compressed image data is continuously stored in a storage area of said temporary storage without a space between blocks.

4. An image data processing method, comprising:
a first procedure of inputting still image data forming a frame, dividing said still image data into blocks each of which contains a predetermined number of consecutive minimum coded units, sequentially selecting a block as a selected block from said blocks in a horizontal-scan direction of said frame, dividing said selected block into a first half block and a second half block at a boundary between minimum coded units, compressing still image data contained in said first half block according to the JPEG standard, adding a restart marker at an end of compressed data of said first half block, compressing still image data contained in said second half block according to the JPEG standard, and storing compressed image data of said second half block next to said restart marker in temporary storage corresponding to said selected block; and
a second procedure of sequentially reading compressed image data of each of said blocks from the temporary storage in the primary scan direction, and adding a restart marker at a head of each of said blocks and outputting.

5. The image data processing method according to claim 4, wherein
said still image data forming said frame is divided into a plurality of areas each including a plurality of blocks, and said first procedure is replaced with a procedure of sequentially selecting a block as a selected block for each area in a horizontal-scan direction in said frame, dividing said selected block into a first half block and a second half block at a boundary between minimum coded units, compressing still image data contained in the first half block according to the JPEG standard, adding a restart marker at an end of compressed data of said first half block, compressing still image data contained in said second half block according to the JPEG standard, and storing compressed image data of said second half block next to said restart marker in temporary storage corresponding to said selected block.

6. The image data processing method according to claim 4, wherein
said compressed image data is continuously stored in a storage area of said temporary storage without a space between blocks.
